(19) United States
(12) Patent Application Publication
(10) Pub. No.: US 2012/0121924 A1
(43) Pub. Date: May 17, 2012

(54) SPEAKER COVER

(75) Inventors: William T. Miller, Allen Park, MI (US); Joel M. Cormier, East Lathrup Village, MI (US); Donald S. Smith, Commerce Township, MI (US)

(73) Assignee: OAKWOOD METAL FABRICATING COMPANY, Dearborn, MI (US)

(21) Appl. No.: 13/298,737

(22) Filed: Nov. 17, 2011

Related U.S. Application Data
(60) Provisional application No. 61/414,652, filed on Nov. 17, 2010.

(51) Int. Cl. B32B 3/24; B21D 43/28

(52) U.S. Cl. 428/596; 72/324

(57) ABSTRACT

A process for producing a speaker grille cover having bands of imperforate metal that have a physical appearance and or audio performance which can be altered or improved to meet styling and/or audio performance objectives. The process comprises these steps, not necessarily executed in the sequence listed: piercing and expanding a sheet of metal to manufacture an area of expanded metal; and interposing an area of imperforate metal between areas of expanded metal. The product made thereby is a speaker grille cover having an area of expanded metal; and bands of imperforate unexpanded metal that are bounded by an area of expanded metal.

### CROSS-REFERENCE TO RELATED APPLICATIONS

This application claims priority to U.S. provisional application no. 61/414,652, filed Nov. 17, 2010, the disclosure of which is incorporated in its entirety by reference herein.

### STATEMENT REGARDING FEDERALLY SPONSORED RESEARCH OR DEVELOPMENT

Not Applicable.

### BACKGROUND OF THE INVENTION

1. Field of the Invention

The invention relates to speaker covers.

2.Background Art

Speaker covers have been a necessity for both home audio and automotive applications for many years to protect the fragile speaker cone from impact damage. These covers have traditionally been manufactured from metal, plastic, composites, fabrics, etc.

One key element in the selection of the appropriate speaker cover is the overall audio performance of the system. This includes the speaker, its orientation, the speaker cover material, the speaker cover open area and pattern, and the surrounding environment in which the speaker is used. Relative to the cover, several of the key elements that affect performance is the amount of open area available for sound transmission, the thickness of the cover material, the material from which the cover is constructed, and the rigidity of the cover.

Metal grilles have been the preferred choice of high end audio systems due to their high open area, thin speaker cover thickness, and overall rigidity. These metal grille products include perforated metal and expanded metal. Expanded metal has proven to be the more cost effective of the two metal technologies when manufactured from low carbon steel. Perforating removes slugs of material that typically result in a hexagonal array of holes with a high open area for sound transmission. Expanded metal, on the other hand, shears and stretches the material to obtain a pattern without the generation of slugs. Depending on the expanded pattern, a 25% to 300% yield based on a linear dimension of raw material may be obtained compared to perforated metal. Additionally, the material is work hardened during the expansion process. This results in a more rigid material as compared to a solid or perforated metal with the same mass per unit area.

One challenge in designing and producing expanded metal speaker grilles is the ability to inexpensively change the pattern within a part. It would be desirable (1) to affordably increase the number styling themes and (2) to provide covers that are non-uniform over their surface area when compared to a traditional expanded metal grille. That would then provide more options to the styling and audio people when they engineer a system.

Another challenge of forming expanded metal grilles is to control the position and shape of form features. These features include coined detail features, crisp form features, hooks, snaps and tabs. While the expanding process work hardens the material, making it more rigid, the strain hardening results in more “spring back” once the part is removed from the forming die. This makes controlling dimensional features, such as snap attachments and surface features, such as very defined form features, difficult if not impossible to control with a high degree of accuracy.

Logos are often added to metal grilles for premium audio systems including Bose, Sony, ELS, etc. Traditionally, add on logos for metal grilles have been added by first piercing holes for attachment and forming a logo depression to accept the add on logo. These logos typically have posts that are either melted or bent down to securely affix the logo to the grille.

Stitched leather and soft touch materials have been used for years to improve the appearance and feel of various automotive and consumer goods. Expanded metal has been known to have a look that appears more like fabric than other grille covers.

The grille is designed to protect the speaker. U.S. Pat. Nos. 4,974,698, 5,565,659, and 5,652,413, incorporated by reference herein, describe metal speaker grilles with snap or tabs features that retain the grille without any secondary mechanical attachments. These grilles allow for serviceability of the speaker assembly system without removing the entire cover assembly. While this feature has proven to function adequately in the field, it required multiple snap attachment points to adequately retain the product since the snap features strictly comprised of expanded metal were devoid of solid metal and were relatively weak.

Perforated metal grilles with solid bands around the periphery have been produced for years with solid bands around the perimeter for home audio applications. However, the perforating process and raw material is more expensive than expanded metal. Therefore, it would be desirable to incorporate solid bands into expanded metal to provide an additional cost benefit to the customer.

Plastic speaker grilles can be designed in a way whose appearance may appear similar to expanded metal grilles. However, the least expensive way to produce these grilles is to incorporate the grill into the substrate and mold it at the same time the door component is molded. These grille covers need to be thicker than metal grilles and have less open area which typically degrades the audio performance of the system. In addition, these “in-molded” grilles cannot be molded out of different colors, which limits the styling options available to the designer. Finally, complex in-molded patters are difficult to mold and can result in an increase in the scrap rate of the modular in-molded grille assembly.

### SUMMARY OF THE INVENTION

The invention affords the designer many additional styling themes through the use of an innovative process to produce the raw material referred to as “Skip Mesh”. “Skip Mesh” allows solid bands of unexpanded or solid metal to be introduced during the manufacturing process. These solid bands can be produced in such a way that the physical appearance and or audio performance can be altered or improved to meet styling and/or audio performance objectives that were previously unavailable to the styling and audio community in the past. See FIG. 1.

The solid bands in a Skip Mesh grill allow areas of higher strength and greater dimensional control where more robust attachments and features can be formed. Relative to attachments features, the product exhibits improved retention force compared to the prior art. Therefore, the overall number of attachments can be reduced.

The disclosed invention will result in smaller blanks and less expensive tooling and a potential piece price savings.

The solid bands in the Skip Mesh provide surface area where crisp form features, such as a bead or a logo depression, can be stamped or coined in during the forming process with a high definition that was not possible in the prior art. Furthermore, they also provide a solid surface which allows for the placement of adhesively applied logos which can be less expensive. This results in an overall component cost that is less expensive than the prior art. See FIG. 2.

In the Skip Mesh grille, the border between the solid band and the expanded metal has an appearance that looks like stitching. The stitch transition between solid and expanded metal provides a surface appearance that cannot easily and inexpensive be replicated with either perforated metal or other cover materials.

By incorporating one or more hooks, snaps, or tabs in the solid band area(s) of the grille, the retention force is significantly improved. These solid areas can also be used to form other traditional metal attachment features like rosettes which can then be used as a robust and repeatable means to adhere the grille to fabric or composite materials such as a rear shelf or package tray. Therefore, the number of attachment points can be reduced to meet pull out force requirements. The solid bands allow the number of attachments to be reduced which simplifies the tooling and reduces the tooling cost since less action is required. Piece price also has the potential of being reduced if the removal of these snaps results in a blank size offsets the cost of the additional solid band material or if it allows for a less expensive logo to be incorporated.

### BRIEF DESCRIPTION OF THE DRAWINGS

FIG. 1 is a formed metal speaker grill with a solid section and an expanded metal section;

FIG. 2 resembles the view depicted in FIG. 1 but illustrates a nameplate area (exemplified by “OAKWOOD”), which may also serve as a product differentiator;

FIG. 3 is a section of expanded metal in which bands of varying width are provided; and

FIG. 4 resembles the view depicted in FIG. 3 but instead has multiple bands of roughly equal width.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

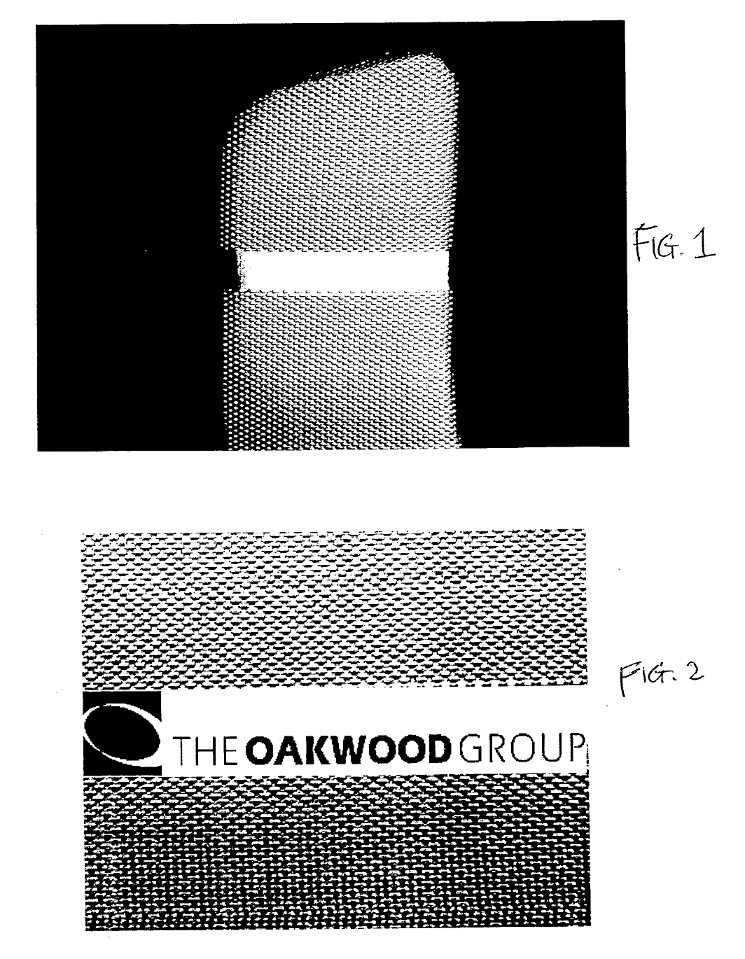

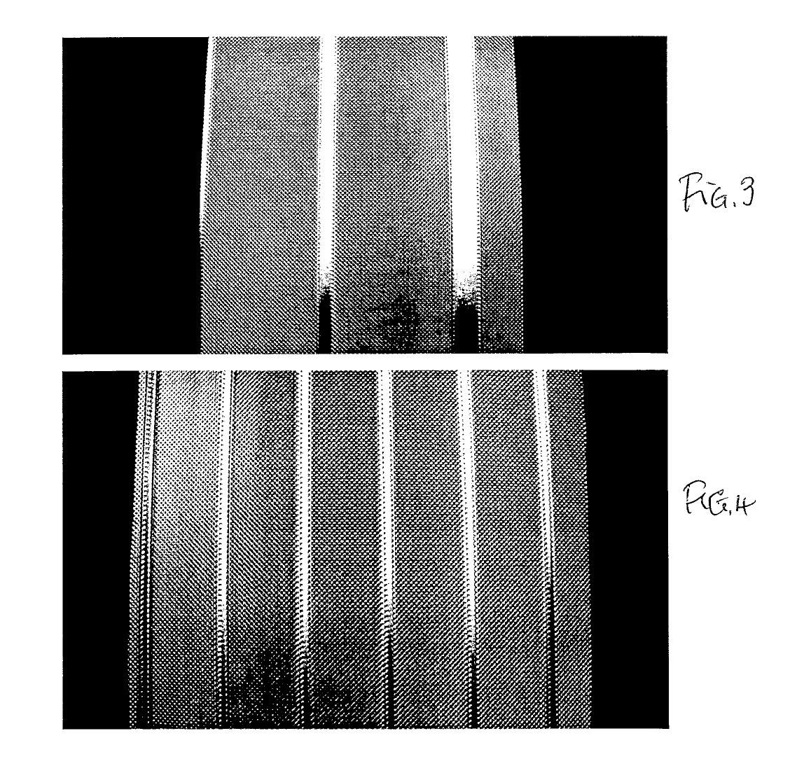

The invention (see FIGS. 1-4) affords the designer many additional styling themes through the use of an innovative process to produce the raw material referred to as “Skip Mesh”. “Skip Mesh” allows solid bands of unexpanded or solid metal to be introduced during the manufacturing process. These solid bands can be produced in such a way that the physical appearance and or audio performance can be altered or improved to meet styling and/or audio performance objectives that were previously unavailable to the styling and audio community in the past.

The solid bands in the Skip Mesh provide a foundation for crisp form features, such as a bead or a logo depression, to be stamped or coined in during the forming process with a high definition that was not possible in the prior art. Furthermore, they also provide a solid surface which allows for placement of adhesively applied logos. This can be less expensive and may result in an overall component cost that is less expensive than the prior art.

The solid bands in the Skip Mesh product provide additional plan strength and provide additional dent resistance.

By incorporating one or more hooks, snaps, rosettes or tabs in the solid band area(s) of the grille, the retention force is significantly improved versus the prior art. Therefore, the overall number of attachments can be reduced and still meet pull force requirements. The solid bands allow the number of attachments to be reduced. This simplifies the tooling and reduces the tooling cost since less action is required. Piece price also has the potential of being reduced if the removal of these snaps results in a blank size that offsets the cost of the additional solid band material or if it allows for a less expensive logo to be incorporated. These solid bands provide increased rigidity that allow for the incorporation of more robust snap-in features that the prior art as described in U.S. Pat. Nos. 4,974,698, 5,565,659, and 5,652,413. This is expected to result in smaller blanks, less expensive tooling and a potential piece price savings.

Expanded metal has been known to have a look that appears more like fabric than other grille covers. The border between the solid band and the expanded metal has an appearance that looks like stitching. The stitch transition between solid and expanded metal provides a surface appearance that cannot easily and inexpensive be replicated with perforated metal and other cover materials.

While the invention can be used with speaker grilles, one can also appreciate the possible benefits in other areas including filtration, batteries, etc.
Attachment methods include:
   Hooks
   Snaps
   Toy tabs
   Rosettes
   Staking
   Clips
   Adhesive
   Welding
Badge options in the solid area include:
   Add on Logos
   Pad Printing
   Detail Printing
   Silk Screen Printing
   Acid Etching
   Paint
   Coined Features
   Punched Features
   Punched and Backlit Features
   Adhesive Applied Films and Foils

As used herein, the term “expanded metal” includes a product that is made from a sheet of metal uniformly slit and stretched, forming diamond-shaped openings in the sheet. The resulting product is a one piece construction that will not unravel and under normal circumstances and will hold its shape for many years. The strands and bonds of the diamond-shaped trusses add strength and rigidity. Expanded metal is available from such suppliers as McNichols at http://www.mcnichols.corn. Expanded metal comes in a standard (raised) or flattened diamond pattern and in a variety of gauges, opening sizes, materials and sheet sizes.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A process for producing a speaker grille cover having bands of imperforate metal that have a physical appearance and audio performance which can be altered or improved to meet styling and audio performance objectives, the process comprising these steps, not necessarily executed in the sequence listed:
a. piercing and expanding a sheet of metal to prepare an area of expanded metal; and
b. interposing an area of imperforate metal between areas of expanded metal.

2. A speaker grille cover having
a. an area of expanded metal; and
b. bands of imperforate metal that are bounded by an area of expanded metal, the bands having a physical appearance and audio performance characteristics which can be altered or improved to meet styling and audio performance objectives.

3. The speaker grill cover of claim 2, wherein the bands of imperforate metal include
a. attachments and features for improved retention of the cover by a surface to which the cover is attached.

4. The speaker grill cover of claim 2, wherein the bands of imperforate metal include a surface area where crisp form features, such as a bead or a logo depression, can be stamped or coined in during a forming process.

5. The speaker grill cover of claim 2, wherein the bands of imperforate metal include a logo placement surface area which allows for the placement of adhesively applied logos.

6. The speaker grill cover of claim 2, further including a border between one band of imperforate metal and an area of expanded metal, the border having an appearance that resembles stitching.

7. The speaker grill cover of claim 3, wherein the attachments are selected from the group consisting of one or more hooks, snaps, rosettes, staking, clips, adhesives, weldments and tabs.

8. The speaker grill cover of claim 5, wherein the adhesively applied logos are selected from the group consisting of printed pads, printed silk screens, acid etched substrates, painted substrates, coined features, punched features, backlit features, films with an applied adhesive, and foils.

9. The speaker grill cover of claim 2, wherein the bands are of unequal width.

10. The speaker grill cover of claim 2, wherein there are multiple bands of equal width.
